(19) United States
(12) Patent Application Publication
(10) Pub. No.: US 2008/0118607 A1
(43) Pub. Date: May 22, 2008

(54) Use of Structured Plant Protein Products to Produce Emulsified Meat Products

(75) Inventors: Arno Sandoval, Wildwood, MO (US); Mac W. Orcutt, St. Louis, MO (US)

Correspondence Address: Solae, LLC, 4300 Duncan Avenue, Legal Department E4, St. Louis, MO, 63110, US

(73) Assignee: Solae, LLC, St. Louis, MO (US)

(21) Appl. No.: 11/942,860

(22) Filed: Nov. 20, 2007

Related U.S. Application Data
(60) Provisional application No. 60/866,791, filed on Nov. 21, 2006.
(60) Provisional application No. 60/908,820, filed on Mar. 29, 2007.

(51) Int. Cl. A23L 1/317; A23L 1/20; A23P 1/12

(52) U.S. Cl. 426/92; 426/506; 426/513; 426/516; 426/656; 426/93

(57) ABSTRACT

The present invention provides emulsified meat products that include animal and simulated meat compositions. In addition, the invention also provides processes for producing the emulsified meat products utilizing animal meat compositions and simulated meat compositions. In the process, the simulated meat composition includes structured plant protein products that are utilized to produce an emulsified meat product with an improved texture.

### CROSS REFERENCE TO RELATED APPLICATIONS

This application claims priority from Provisional Application Ser. No. 60/908,820 filed on Mar. 29, 2007 and from Provisional Application Ser. No. 60/866,791 filed on Nov. 21, 2006, which are hereby incorporated by reference in their entirety.

### FIELD OF THE INVENTION

The present invention provides for emulsified meat products that include animal and simulated meat compositions. The invention also provides processes for producing the emulsified meat products utilizing animal meat compositions and simulated meat compositions. In the process, the simulated meat composition includes structured plant protein products that are utilized to produce an emulsified meat product.

### BACKGROUND OF THE INVENTION

Food scientists have devoted much time developing methods for preparing acceptable meat-like food products, such as beef, pork, poultry, fish, and shellfish analogs, from a wide variety of plant proteins. Soy protein has been utilized as a protein source because of its relative abundance and reasonably low cost. Extrusion processes typically prepare meat analogs. Upon extrusion, the extrudate generally expands to form a fibrous material. To date, meat analogs made from high protein extrudates have had limited acceptance because they lack meat-like texture characteristics and mouth feel. Rather, they are characterized as spongy and chewy, largely due to the random, twisted nature of the protein fibers that are formed. Most are used as extenders for ground, hamburger-type meats. Thus, there is an unmet need for a structured plant protein product that simulates the fibrous structure of animal meat and has an acceptable meat-like texture, flavor and color.

The term texture describes a wide variety of physical properties of a food product. A product of acceptable texture is usually synonymous with the quality of a product. Texture is an attribute of a substance resulting from physical properties and perceived senses of touch, including kinaestheses feel, sight, and hearing. Texture, as defined by the International Organization of Standardization, is “all of the theological and structural (geometric and surface) attributes of a food product perceptible by means of mechanical, tactual and, where appropriate, visual and auditory receptors.”

Accelerated attention has been given to texture as it pertains to newer food substances including fabricated and imitation products, formed meat and fish products, where processing steps are designed to duplicate the properties of the original or other natural food substances. The use of non-traditional raw materials, synthetic flavors, fillers, and extenders all tend to alter certain textural characteristics of the finished product. Frequently, the imitation of textural properties is of much greater difficulty than the replication of taste, odors, and colors. Numerous manipulative processes, including extrusion texturization, have been developed to simulate natural textural properties. Generally, the processors find it prudent to duplicate the properties of the original substances to the extent feasible technically and economically in order to promote early market acceptance. While texture has attributes related to appearance, it also has attributes related to touch and mouth feel or interaction of food when it comes in contact with the mouth. Frequently, these sensory perceptions involved with chewing can relate to impressions of either desirability or undesirability.

Thus, textural terms include terms relating to the behavior of the material under stress or strain and include, for example, the following: firm, hard, soft, tough, tender, chewy, rubbery, elastic, plastic, sticky, adhesive, tacky, crispy, crunchy, etc. Secondly, texture terms may be related to the structure of the material: smooth, fine, powdery, chalky, lumpy, mealy, coarse, gritty, etc. Thirdly, texture terms may relate to the shape and arrangement of structural elements, such as: flaky, fibrous, stringy, pulpy, cellular, crystalline, glassy, spongy, etc. Lastly, texture terms may relate to mouth feel characteristics, including: mouth feel, body, dry, moist, wet, watery, waxy, slimy, mushy, etc.

Thus, there is an unmet need for the development of an untexturized protein product into a texturized protein product. Particularly, a product and method for taking an untexturized, paste-like, batter-like protein product with no visible grain or texture and converting it into a texturized, protein product with a definite shape, meat-like texture, and acceptable mouth feel.

### SUMMARY OF THE INVENTION

One aspect of the invention provides a process for producing a structured plant protein product. The plant protein material is extruded under conditions of elevated temperature and pressure to form a structured plant protein product comprising protein fibers that are substantially aligned.

Yet another aspect of the invention provides a process for producing an emulsified meat product. In general, the emulsified meat product comprises animal meat compositions, including comminuted animal meat, and a structured plant protein product comprising protein fibers that are substantially aligned, producing an emulsified meat product with an improved texture and mouth feel.

A further aspect of the invention provides an emulsified meat composition from a simulated meat composition. The simulated meat composition comprises a structured plant protein product comprising protein fibers that are substantially aligned.

### REFERENCE TO COLOR FIGS

The application contains at least one photograph executed in color. Copies of this patent application publication with color photographs will be provided by the Office upon request and payment of the necessary fee.

### FIGURE LEGENDS

FIG. 1 depicts a photographic image of a micrograph showing a structured plant protein product of the invention having protein fibers that are substantially aligned.

FIG. 2 depicts a photographic image of a micrograph showing a plant protein product not produced by the process of the present invention. The protein fibers comprising the plant protein product, as described herein, are crosshatched.

### DETAILED DESCRIPTION OF THE INVENTION

The present invention provides emulsified meat products created from animal meat compositions or simulated meat compositions. The invention also provides a process of producing the emulsified meat products. The emulsified meat products comprise structured plant protein products comprising protein fibers that are substantially aligned and that may optionally include animal meat. The structured plant protein products are combined with animal meat compositions or replace the animal meat compositions to create an emulsified meat product with a texturized structure. As shown in the photographic images, the plant protein product produced according to the current invention demonstrates fiber consistency substantially more aligned, which is more of a meat-like texture as compared to traditional plant protein products, which have a more gummy and less cohesive consistency. Because of the improved texture and flavor, resultant compositions of the invention may be utilized in a variety of applications to simulate whole muscle meat. In another embodiment, the animal meat compositions include texturized animal meat such as whole muscle fibers, untexturized animal meat such as comminuted meat or mechanically deboned meat (MDM), or combinations of both.

### (I) Structured Plant Protein Products

The emulsified meat products, animal meat compositions, and simulated meat compositions of the invention can each comprise structured plant protein products comprising protein fibers that are substantially aligned, as described in more detail in I(e) below. In an exemplary embodiment, the structured plant protein products are extrudates of plant materials that have been subjected to the extrusion process detailed in I(d) below. Because the structured plant protein products utilizing the extrusion process in I(d) have protein fibers that are substantially aligned in a manner similar to animal meat, the animal meat compositions and simulated meat compositions generally have the texture and feel of compositions containing animal meat.

(a) Protein-Containing Starting Material

A variety of ingredients that contain protein may be utilized in an extrusion process to produce structured plant protein products suitable for use in the invention. While ingredients comprising proteins derived from plants are typically used, it is also envisioned that proteins derived from sources other than typical animal meat products may be utilized without departing from the scope of the invention. For example, a dairy protein selected from the group consisting of casein, caseinates, whey protein, and mixtures thereof may be utilized. In an exemplary embodiment, the dairy protein is whey protein. By way of further example, an egg protein selected from the group consisting of ovalbumin, ovoglobulin, ovomucin, ovomucoid, ovotransferrin, ovovitella, ovovitellin, albumin globulin, and vitellin may be utilized.

It is envisioned that other ingredient additives in addition to proteins may be utilized. Non-limiting examples of such ingredients include sugars, starches, oligosaccharides, soy fiber and other dietary fibers, and gluten.

It is also envisioned that the protein-containing starting materials may be gluten-free. Because gluten is typically used in filament formation during the extrusion process, if a gluten-free starting material is used, an edible crosslink agent may be utilized to facilitate filament formation. Non-limiting examples of suitable crosslink agents include Konjac glucomannan (KGM) flour, edible crosslink agents, beta glucan, such as Pureglucan® manufactured by Takeda (USA), calcium salts, magnesium salts, and transglutaminase. One skilled in the art can readily determine the amount of cross linker needed, if any, in gluten-free embodiments.

Irrespective of its source or ingredient classification, the ingredients utilized in the extrusion process are typically capable of forming structured plant protein products having protein fibers that are substantially aligned. Suitable examples of such ingredients are detailed more fully below.

(i) Plant Protein Materials

In an exemplary embodiment, at least one ingredient derived from a plant will be utilized to form the protein-containing materials. Generally speaking, the ingredient will comprise a protein. The amount of protein present in the ingredient(s) utilized can and will vary depending upon the application. For example, the amount of protein present in the ingredient(s) utilized may range from about 40% to about 100% by weight. In another embodiment, the amount of protein present in the ingredient(s) utilized may range from about 50% to about 100% by weight. In an additional embodiment, the amount of protein present in the ingredient(s) utilized may range from about 60% to about 100% by weight. In a further embodiment, the amount of protein present in the ingredient(s) utilized may range from about 70% to about 100% by weight. In still another embodiment, the amount of protein present in the ingredient(s) utilized may range from about 80% to about 100% by weight. In a further embodiment, the amount of protein present in the ingredient(s) utilized may range from about 90% to about 100% by weight.

The ingredient(s) utilized in extrusion may be derived from a variety of suitable plants. By way of non-limiting examples, suitable plants include legumes, corn, peas, canola, sunflowers, sorghum, rice, amaranth, potato, tapioca, arrowroot, canna, lupin, rape seed, wheat, oats, rye, barley, and mixtures thereof.

In one embodiment, the ingredients are isolated from wheat and soybeans. In another exemplary embodiment, the ingredients are isolated from soybeans. In a further embodiment, the ingredients are isolated from wheat. Suitable wheat derived protein-containing ingredients include wheat gluten, wheat flour, and mixtures thereof. Examples of commercially available wheat gluten that may be utilized in the invention include Gem of the Star Gluten, Vital Wheat Gluten (organic) each of which is available from Manildra Milling. Suitable soybean derived protein-containing ingredients (“soy protein material”) include soybean protein isolate, soy protein concentrate, soy flour, and mixtures thereof, each of which are detailed below. In each of the foregoing embodiments, the soybean material may be combined with one or more ingredients selected from the group consisting of a starch, flour, gluten, a dietary fiber, and mixtures thereof.

Suitable examples of protein-containing material isolated from a variety of sources are detailed in Table A, which shows various combinations.

TABLE A
Protein Combinations

| First protein source | second ingredient |
|---|---|
| Soybean | wheat |
| Soybean | dairy |
| Soybean | egg |
| Soybean | corn |
| Soybean | rice |
| Soybean | barley |
| Soybean | sorghum |
| Soybean | oat |
| Soybean | millet |
| Soybean | rye |
| Soybean | triticale |
| Soybean | buckwheat |
| Soybean | pea |
| Soybean | peanut |
| Soybean | lentil |
| Soybean | lupin |
| Soybean | channa (garbonzo) |
| Soybean | rapeseed (canola) |
| Soybean | cassava |
| Soybean | sunflower |
| Soybean | whey |
| Soybean | tapioca |
| Soybean | arrowroot |
| Soybean | amaranth |
| Soybean | wheat and dairy |
| Soybean | wheat and egg |
| Soybean | wheat and corn |
| Soybean | wheat and rice |
| Soybean | wheat and barley |
| Soybean | wheat and sorghum |
| Soybean | wheat and oat |
| Soybean | wheat and millet |
| Soybean | wheat and rye |
| Soybean | wheat and triticale |
| Soybean | wheat and buckwheat |
| Soybean | wheat and pea |
| Soybean | wheat and peanut |
| Soybean | wheat and lentil |
| Soybean | wheat and lupin |
| Soybean | wheat and channa |
| | (garbonzo) |
| Soybean | wheat and rapeseed |
| | (canola) |
| Soybean | wheat and cassava |
| Soybean | wheat and sunflower |
| Soybean | wheat and potato |
| Soybean | wheat and tapioca |
| Soybean | wheat and arrowroot |
| Soybean | wheat and amaranth |
| Soybean | corn and wheat |
| Soybean | corn and dairy |
| Soybean | corn and egg |
| Soybean | corn and rice |
| Soybean | corn and barley |
| Soybean | corn and sorghum |
| Soybean | corn and oat |
| Soybean | corn and millet |
| Soybean | corn and rye |
| Soybean | corn and triticale |
| Soybean | corn and buckwheat |
| Soybean | corn and pea |
| Soybean | corn and peanut |
| Soybean | corn and lentil |
| Soybean | corn and lupin |
| Soybean | corn and channa |
| | (garbonzo) |
| Soybean | corn and rapeseed (canola) |
| Soybean | corn and cassava |
| Soybean | corn and sunflower |
| Soybean | corn and potato |
| Soybean | corn and tapioca |
| Soybean | corn and arrowroot |
| Soybean | corn and amaranth |

In each of the embodiments delineated in Table A, the combination of protein-containing materials may be combined with one or more ingredients selected from the group consisting of a starch, flour, gluten, dietary fiber, and mixtures thereof. In one embodiment, the protein-containing material comprises protein, starch, gluten, and fiber. In an exemplary embodiment, the protein-containing material comprises from about 45% to about 65% soy protein on a dry matter basis; from about 20% to about 30% wheat gluten on a dry matter basis; from about 10% to about 15% wheat starch on a dry matter basis; and from about 1% to about 5% starch on a dry matter basis. In each of the foregoing embodiments, the protein-containing material may comprise dicalcium phosphate, L-cysteine or combinations of both dicalcium phosphate and L-cysteine.

(ii) Soy Protein Materials

In an exemplary embodiment, as detailed above, soy protein isolate, soy protein concentrate, soy flour, and mixtures thereof may be utilized in the extrusion process. The soy protein materials may be derived from whole soybeans in accordance with methods generally known in the art. The whole soybean may be standard soybeans (i.e., non genetically modified soybeans), commoditized soybeans, genetically modified soybeans, and combinations thereof.

Generally speaking, when soy isolate is used, an isolate is preferably selected that is not a highly hydrolyzed soy protein isolate. In certain embodiments, highly hydrolyzed soy protein isolates, however, may be used in combination with other soy protein isolates provided that the highly hydrolyzed soy protein isolate content of the combined soy protein isolates is generally less than about 40% of the combined soy protein isolates, by weight. Additionally, the soy protein isolate utilized preferably has an emulsion strength and gel strength sufficient to enable the protein in the isolate to form fibers that are substantially aligned upon extrusion. Examples of soy protein isolates that are useful in the present invention are available commercially, for example, from Solae, LLC (St. Louis, Mo.), and include SUPRO® 500E, SUPRO® EX 33, SUPRO® 620, and SUPRO® 545. In an exemplary embodiment, a form of SUPRO® 620 is utilized as detailed in Example 4.

Alternatively, soy protein concentrate may be blended with the soy protein isolate to substitute for a portion of the soy protein isolate as a source of soy protein material. Typically, if a soy protein concentrate is substituted for a portion of the soy protein isolate, the soy protein concentrate is substituted for up to about 40% of the soy protein isolate by weight, at most, and more preferably is substituted for up to about 30% of the soy protein isolate by weight. Examples of suitable soy protein concentrates useful in the invention include Promine, ALPHA™ DSP-C, Procon™ 2000, Alpha™ 12 and Alpha™ 5800, which are commercially available from Solae, LLC (St. Louis, Mo.).

Soy cotyledon fiber may optionally be utilized as a fiber source. Typically, suitable soy cotyledon fiber will generally effectively bind water when the mixture of soy protein and soy cotyledon fiber is co-extruded. In this context, “effectively bind water” generally means that the soy cotyledon fiber has a water holding capacity of at least 5.0 to about 8.0 grams of water per gram of soy cotyledon fiber, and preferably the soy cotyledon fiber has a water holding capacity of at least about 6.0 to about 8.0 grams of water per gram of soy cotyledon fiber. Soy cotyledon fiber may generally be present in the soy protein material in an amount ranging from about 1% to about 20%, preferably from about 1.5% to about 20% and most preferably, at from about 2% to about 5% by weight on a moisture free basis. Suitable soy cotyledon fiber is commercially available. For example, FIBRIM® 1260 and FIBRIM® 2000 are soy cotyledon fiber materials that are commercially available from Solae, LLC (St. Louis, Mo.).

(b) Additional Ingredients

A variety of additional ingredients may be added to any of the combinations of protein-containing materials above without departing from the scope of the invention. For example, antioxidants, antimicrobial agents, and combinations thereof may be included. Antioxidant additives include BHA, BHT, TBHQ, vitamins A, C and E and derivatives thereof, and various plant extracts such as those containing carotenoids, tocopherols or flavonoids having antioxidant properties, may be included to increase the shelf-life or nutritionally enhance the animal meat compositions or simulated meat compositions. The antioxidants and the antimicrobial agents may have a combined presence at levels of from about 0.01% to about 10%, preferably, from about 0.05% to about 5%, and more preferably from about 0.1% to about 2%, by weight of the protein-containing materials that will be extruded.

(c) Moisture Content

As will be appreciated by the skilled artisan, the moisture content of the protein-containing materials can and will vary depending upon the extrusion process. Generally speaking, the moisture content may range from about 1% to about 80% by weight. In low moisture extrusion applications, the moisture content of the protein-containing materials may range from about 1% to about 35% by weight. Alternatively, in high moisture extrusion applications, the moisture content of the protein-containing materials may range from about 35% to about 80% by weight. In an exemplary embodiment, the extrusion application utilized to form the extrudates is low moisture. An exemplary example of a low moisture extrusion process to produce extrudates having proteins with fibers that are substantially aligned is detailed in I(e) and Example 4.

(d) Extrusion of the Plant Material

A suitable extrusion process for the preparation of a plant protein material comprises introducing the plant protein material and other ingredients into a mixing tank (i.e., an ingredient blender) to combine the ingredients and form a dry blended plant protein material pre-mix. The dry blended plant protein material pre-mix is then transferred to a hopper from which the dry blended ingredients are introduced along with moisture into a pre-conditioner to form a conditioned plant protein material mixture. The conditioned material is then fed to an extruder in which the plant protein material mixture is heated under mechanical pressure generated by the screws of the extruder to form a molten extrusion mass. The molten extrusion mass exits the extruder through an extrusion die.

(i) Extrusion Process Conditions

Among the suitable extrusion apparatuses useful in the practice of the present invention is a double barrel, twin-screw extruder as described, for example, in U.S. Pat. No. 4,600,311. Further examples of suitable commercially available extrusion apparatuses include a CLEXTRAL Model BC-72 extruder manufactured by Clextral, Inc. (Tampa, Fla.); a WENGER Model TX-57 extruder, a WENGER Model TX-168 extruder, and a WENGER Model TX-52 extruder all manufactured by Wenger Manufacturing, Inc. (Sabetha, Kans.). Other conventional extruders suitable for use in this invention are described, for example, in U.S. Pat. Nos. 4,763,569, 4,118,164, and 3,117,006, which are hereby incorporated by reference in their entirety. A single-screw extruder could also be used in the present invention. Examples of suitable, commercially available single-screw extrusion apparatuses include the Wenger X-175, the Wenger X-165, and the Wenger X-85 all of which are available from Wenger Manufacturing, Inc.

The screws of a twin-screw extruder can rotate within the barrel in the same or opposite directions. Rotation of the screws in the same direction is referred to as single flow or co-rotating whereas rotation of the screws in opposite directions is referred to as double flow or counter-rotating. The speed of the screw or screws of the extruder may vary depending on the particular apparatus; however, it is typically from about 250 to about 450 revolutions per minute (rpm). Generally, as the screw speed increases, the density of the extrudate will decrease. The extrusion apparatus contains screws assembled from shafts and worm segments, as well as mixing lobe and ring-type shearing elements as recommended by the extrusion apparatus manufacturer for extruding plant protein material.

The extrusion apparatus generally comprises a plurality of heating zones through which the protein mixture is conveyed under mechanical pressure prior to exiting the extrusion apparatus through an extrusion die. The temperature in each successive heating zone generally exceeds the temperature of the previous heating zone by between about 10° C. to about 70° C. In one embodiment, the conditioned pre-mix is transferred through four heating zones within the extrusion apparatus, with the protein mixture heated to a temperature of from about 100° C. to about 150° C. such that the molten extrusion mass enters the extrusion die at a temperature of from about 100° C. to about 150° C. There is no active heating or cooling necessary. Typically, temperature changes are due to work input and can happen suddenly.

The pressure within the extruder barrel is typically between about 50 psig to about 500 psig, preferably between about 75 psig to about 200 psig. Generally the pressure within the last two heating zones is from about 100 psig to about 3000 psig, preferably between about 150 psig to about 500 psig. The barrel pressure is dependent on numerous factors including, for example, the extruder screw speed, feed rate of the mixture to the barrel, feed rate of water to the barrel, and the viscosity of the molten mass within the barrel.

Water is injected into the extruder barrel to hydrate the plant protein material mixture and promote texturization of the proteins. As an aid in forming the molten extrusion mass, the water may act as a plasticizing agent. Water may be introduced to the extruder barrel via one or more injection jets in communication with a heating zone. Typically, the mixture in the barrel contains from about 15% to about 30% by weight water. The rate of introduction of water to any of the heating zones is generally controlled to promote production of an extrudate having desired characteristics. It has been observed that as the rate of introduction of water to the barrel decreases, the density of the extrudate decreases. Typically, less than about 1 kg of water per kg of protein is introduced to the barrel. Preferably, from about 0.1 kg to about 1 kg of water per kg of protein are introduced to the barrel.

(ii) Preconditioning

In a pre-conditioner, the protein-containing material and other ingredients (protein-containing mixture) can be preheated, contacted with moisture, and held under controlled temperature and pressure conditions to allow the moisture to penetrate and soften the individual particles. The preconditioner contains one or more paddles to promote uniform mixing of the protein and transfer of the protein mixture through the preconditioner. The configuration and rotational speed of the paddles vary widely, depending on the capacity of the preconditioner, the extruder throughput and/or the desired residence time of the mixture in the preconditioner or extruder barrel. Generally, the speed of the paddles is from about 100 to about 1300 revolutions per minute (rpm). Agitation must be high enough to obtain even hydration and good mixing.

Typically, the protein-containing mixture is pre-conditioned prior to introduction into the extrusion apparatus by contacting the pre-mix with moisture (i.e., steam and/or water). Preferably the protein-containing mixture is heated to a temperature of from about 25° C. to about 80° C., more preferably from about 30° C. to about 40° C. in the preconditioner.

Typically, the plant protein material pre-mix is conditioned for a period of about 30 to about 60 seconds, depending on the speed and the size of the conditioner. The plant protein material pre-mix is contacted with steam and/or water and heated in the pre-conditioner at generally constant steam flow to achieve the desired temperatures. The water and/or steam conditions (i.e., hydrates) the plant protein material mixture, increases its density, and facilitates the flowability of the dried mix without interference prior to introduction to the extruder barrel where the proteins are texturized. If a low moisture plant protein material is desired, the conditioned pre-mix may contain from about 1% to about 35% (by weight) water. If a high moisture plant protein material is desired, the conditioned pre-mix may contain from about 35% to about 80% (by weight) water.

The conditioned pre-mix typically has a bulk density of from about 0.25 g/cm³ to about 0.6 g/cm³. Generally, as the bulk density of the pre-conditioned protein mixture increases within this range, the protein mixture is easier to process. This is presently believed to be due to such mixtures occupying all or a majority of the space between the screws of the extruder, thereby facilitating conveying the extrusion mass through the barrel.

(iii) Extrusion Process

The conditioned pre-mix is then fed into an extruder to heat, shear, and ultimately plasticize the mixture. The extruder may be selected from any commercially available extruder and may be a single screw extruder or preferably a twin-screw extruder that mechanically shears the mixture with the screw elements.

Whichever extruder is used, it should be run in excess of about 50% motor load. Typically, the conditioned pre-mix is introduced to the extrusion apparatus at a rate of between about 16 kilograms per minute to about 60 kilograms per minute. More preferably, the conditioned pre-mix is introduced to the extrusion apparatus at a rate of between about 26 kilograms per minute to about 32 kilograms per minute. Generally, it has been observed that the density of the extrudate decreases as the feed rate of pre-mix to the extruder increases.

The pre-mix is subjected to shear and pressure by the extruder to plasticize the mixture. The screw elements of the extruder shear the mixture as well as create pressure in the extruder by forcing the mixture forwards though the extruder and through the die. Preferably, the screw motor speed is set to a speed of from about 200 rpm to about 500 rpm, and more preferably from about 300 rpm to about 450 rpm, which moves the mixture through the extruder at a rate of at least about 20 kilograms per minute, and more preferably at least about 40 kilograms per minute. Preferably the extruder generates an extruder barrel exit pressure of from about 50 psig to about 3000 psig.

The extruder heats the protein mixture as it passes through the extruder denaturing the protein in the mixture. The extruder includes a means for heating the mixture to temperatures of from about 100° C. to about 180° C. Preferably the means for heating the mixture in the extruder comprises extruder barrel jackets into which heating or cooling media such as steam or water may be introduced to control the temperature of the mixture passing through the extruder. The extruder may also include steam injection ports for directly injecting steam into the mixture within the extruder. The extruder preferably includes multiple heating zones that can be controlled to independent temperatures, where the temperatures of the heating zones are preferably set to increase the temperature of the mixture as it proceeds through the extruder. For example, the extruder may be set in a four temperature zone arrangement, where the first zone (adjacent the extruder inlet port) is set to a temperature of from about 80° C. to about 100° C., the second zone is set to a temperature of from about 100° C. to 135° C., the third zone is set to a temperature of from 135° C. to about 150° C., and the fourth zone (adjacent the extruder exit port) is set to a temperature of from about 150° C. to about 180° C. The extruder may be set in other temperature zone arrangements, as desired. For example, the extruder may be set in a five temperature zone arrangement, where the first zone is set to a temperature of about 25° C., the second zone is set to a temperature of about 50° C., the third zone is set to a temperature of about 95° C., the fourth zone is set to a temperature of about 130° C., and the fifth zone is set to a temperature of about 150° C.

The mixture forms a melted plasticized mass in the extruder. A die assembly is attached to the extruder in an arrangement that permits the plasticized mixture to flow from the extruder exit port into the die assembly, wherein the die assembly consists of a die and a backplate. The backplate is attached to the inner face of the die for the purpose of directing the flow of material entering the die towards the die aperture(s). Additionally, the die assembly produces substantial alignment of the protein fibers within the plasticized mixture as it flows through the die assembly. The backplate in combination with the die create a central chamber that receives the melted plasticized mass from the extruder through a central opening. From the central chamber, the melted plasticized mass is directed by flow directors into at least one elongated tapered channel. Each elongated tapered channel leads directly to an individual die aperture. The extrudate exits the die through at least one aperture in the periphery or side of the die assembly at which point the protein fibers contained within are substantially aligned. It is also contemplated that the extrudate may exit the die assembly through at least one aperture in the die face, which may be a die plate affixed to the die.

The width and height dimensions of the die aperture(s) are selected and set prior to extrusion of the mixture to provide the fibrous material extrudate with the desired dimensions. The width of the die aperture(s) may be set so that the extrudate resembles from a cubic chunk of meat to a steak filet, where widening the width of the die aperture(s) decreases the cubic chunk-like nature of the extrudate and increases the filet-like nature of the extrudate. Preferably the width of the die aperture(s) is/are set to a width of from about 10 millimeters to about 40 millimeters.

The height dimension of the die aperture(s) may be set to provide the desired thickness of the extrudate. The height of the aperture(s) may be set to provide a very thin extrudate or a thick extrudate. Preferably, the height of the die aperture(s) may be set to from about 1 millimeter to about 30 millimeters, and more preferably from about 8 millimeters to about 16 millimeters.

It is also contemplated that the die aperture(s) may be round. The diameter of the die aperture(s) may be set to provide the desired thickness of the extrudate. The diameter of the aperture(s) may be set to provide a very thin extrudate or a thick extrudate. Preferably, the diameter of the die aperture(s) may be set to from about 1 millimeter to about 30 millimeters, and more preferably from about 8 millimeters to about 16 millimeters.

The extrudate is cut after exiting the die assembly. Suitable apparatuses for cutting the extrudate include flexible knives manufactured by Wenger Manufacturing, Inc. (Sabetha, Kans.) and Clextral, Inc. (Tampa, Fla.).

The dryer, if one is used, generally comprises a plurality of drying zones in which the air temperature may vary. Generally, the temperature of the air within one or more of the zones will be from about 135° C. to about 185° C. Typically, the extrudate is present in the dryer for a time sufficient to provide an extrudate having a desired moisture content. Generally, the extrudate is dried for at least about 5 minutes and preferably for at least about 10 minutes up to about 60 minutes. Suitable dryers include those manufactured by Wolverine Proctor & Schwartz (Merrimac, Mass.), National Drying Machinery Co. (Philadelphia, Pa.), Wenger (Sabetha, Kans.), Clextral (Tampa, Fla.), and Buehler (Lake Bluff, Ill.).

The desired moisture content may vary widely depending on the intended application of the extrudate. Generally speaking, the extruded material has a moisture content of from about 6% to about 13% by weight, if dried, and needs to be hydrated in water until the water is absorbed and the fibers are separated. If the protein material is not dried or not fully dried, its moisture content is higher, generally from about 16% to about 30% by weight.

The dried extrudate may further be comminuted to reduce the average particle size of the extrudate. Suitable grinding apparatus include hammer mills such as Mikro Hammer Mills manufactured by Hosokawa Micron Ltd. (England). The dried extrudate may further be comminuted to reduce the average particle size of the extrudate. Suitable grinding apparatus include hammer mills such as Mikro Hammer Mills manufactured by Hosokawa Micron Ltd. (England), Fitzmill® manufactured by the Fitzpatrick Company (Elmhurst, Ill.), Comitrol® processors made by Urschel Laboratories, Inc. (Valparaiso, Ind.), and roller mills such as RossKamp Roller Mills manufactured by RossKamp Champion (Waterloo, Ill.).

Typically, the reduced extrudate has an average particle size of from about 0.5 mm to about 40.0 mm. In one embodiment, the reduced extrudate has an average particle size of from about 1.0 mm to about 30.0 mm. In another embodiment, the reduced extrudate has an average particle size of from about 1.0 mm to about 20.0 mm. In a further embodiment, the reduced extrudate has an average particle size of from about 1.0 mm to about 15.0 mm. In an additional embodiment, the reduced extrudate has an average particle size of from about 1.5 mm to about 10.0 mm. In yet another embodiment, the reduced extrudate has an average particle size of from about 2.0 mm to about 6.0 mm. Suitable grinding apparatus include hammer mills such as Mikro Hammer Mills manufactured by Hosokawa Micron Ltd. (England) and Comitrol® processors made by Urschel Laboratories, Inc. (Valparaiso, Ind.).

(e) Characterization of the Structured Plant Protein Products

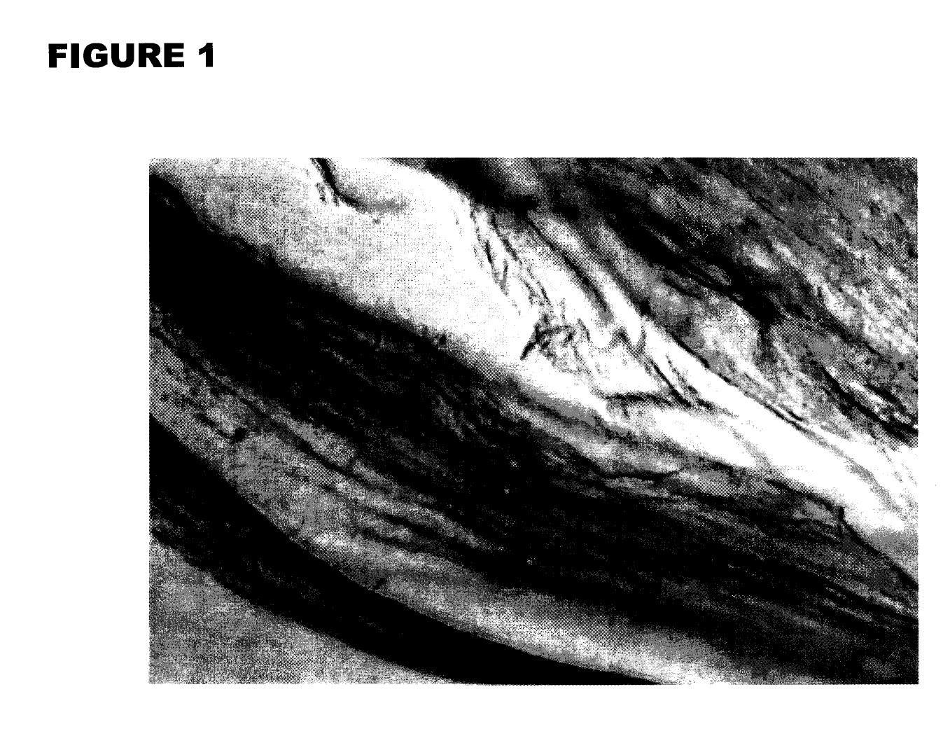

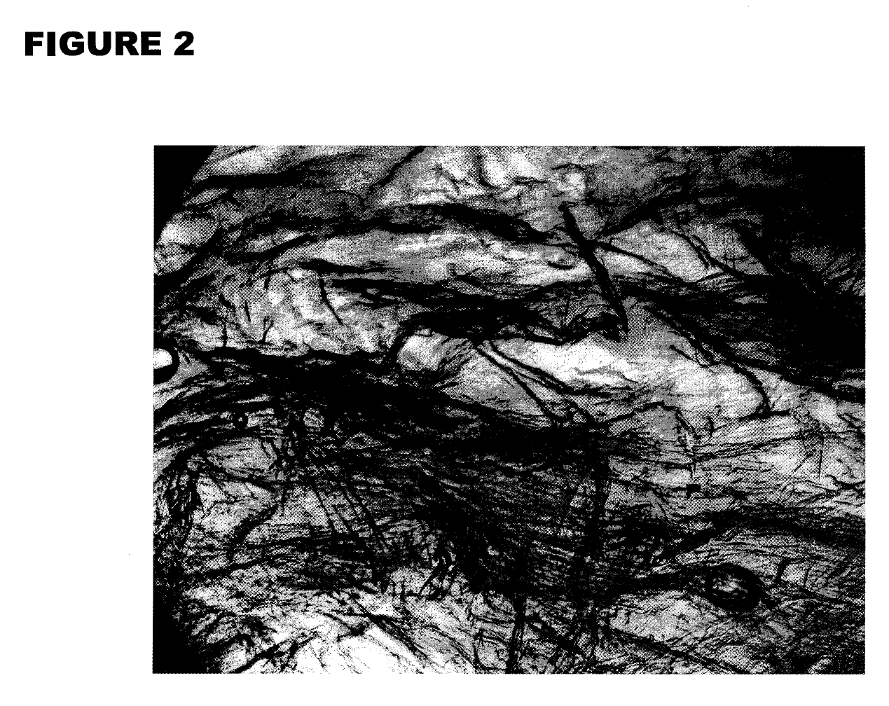

The extrudates produced in I(d) typically comprise the structured plant protein products comprising protein fibers that are substantially aligned. In the context of this invention “substantially aligned” generally refers to the arrangement of protein fibers such that a significantly high percentage of the protein fibers forming the structured plant protein product are contiguous to each other at less than approximately a 45° angle when viewed in a horizontal plane. Typically, an average of at least 55% of the protein fibers comprising the structured plant protein product are substantially aligned. In another embodiment, an average of at least 60% of the protein fibers comprising the structured plant protein product are substantially aligned. In a further embodiment, an average of at least 70% of the protein fibers comprising the structured plant protein product are substantially aligned. In an additional embodiment, an average of at least 80% of the protein fibers comprising the structured plant protein product are substantially aligned. In yet another embodiment, an average of at least 90% of the protein fibers comprising the structured plant protein product are substantially aligned. Methods for determining the degree of protein fiber alignment are known in the art and include visual determinations based upon micrographic images. By way of example, FIGS. 1 and 2 depict micrographic images that illustrate the difference between a structured plant protein product having substantially aligned protein fibers compared to a plant protein product having protein fibers that are significantly crosshatched. FIG. 1 depicts a structured plant protein product prepared according to I (a)-I (d) having protein fibers that are substantially aligned. Contrastingly, FIG. 2 depicts a plant protein product containing protein fibers that are significantly crosshatched and not substantially aligned. Because the protein fibers are substantially aligned, as shown in FIG. 1, the structured plant protein products utilized in the invention generally have the texture and consistency of cooked muscle meat. The plant protein products have the general characteristic of texturized muscle meat. In contrast, traditional extrudates having protein fibers that are randomly oriented or crosshatched generally have a texture that is soft or spongy.

In addition to having protein fibers that are substantially aligned, the structured plant protein products also typically have shear strength substantially similar to whole meat muscle. In this context of the invention, the term “shear strength” provides one means to quantify the formation of a sufficient fibrous network to impart whole-muscle like texture and appearance to the plant protein product. Shear strength is the maximum force in grams needed to shear or cut through a given sample. A method for measuring shear strength is described in Example 3. Generally speaking, the structured plant protein products of the invention will have average shear strength of at least 1400 grams. In an additional embodiment, the structured plant protein products will have average shear strength of from about 1500 to about 1800 grams. In yet another embodiment, the structured plant protein products will have average shear strength of from about 1800 to about 2000 grams. In a further embodiment, the structured plant protein products will have average shear strength of from about 2000 to about 2600 grams. In an additional embodiment, the structured plant protein products will have average shear strength of at least 2200 grams. In a further embodiment, the structured plant protein products will have average shear strength of at least 2300 grams. In yet another embodiment, the structured plant protein products will have average shear strength of at least 2400 grams. In still another embodiment, the structured plant protein products will have average shear strength of at least 2500 grams. In a further embodiment, the structured plant protein products will have average shear strength of at least 2600 grams.

A means to quantify the size of the protein fibers formed in the structured plant protein products may be done by a shred characterization test. Shred characterization is a test that generally determines the percentage of large pieces formed in the structured plant protein product. In an indirect manner, percentage of shred characterization provides an additional means to quantify the degree of protein fiber alignment in a structured plant protein product. Generally speaking, as the percentage of large pieces increases, the degree of protein fibers that are aligned within a structured plant protein product also typically increases. Conversely, as the percentage of large pieces decreases, the degree of protein fibers that are aligned within a structured plant protein product also typically decreases. A method for determining shred characterization is detailed in Example 4. The structured plant protein products of the invention typically have an average shred characterization of at least 10% by weight of large pieces. In a further embodiment, the structured plant protein products have an average shred characterization of from about 10% to about 15% by weight of large pieces. In another embodiment, the structured plant protein products have an average shred characterization of from about 15% to about 20% by weight of large pieces. In yet another embodiment, the structured plant protein products have an average shred characterization of from about 20% to about 25% by weight of large pieces. In another embodiment, the average shred characterization is at least 20% by weight, at least 21% by weight, at least 22% by weight, at least 23% by weight, at least 24% by weight, at least 25% by weight, or at least 26% by weight large pieces.

Suitable structured plant protein products of the invention generally have protein fibers that are substantially aligned, have average shear strength of at least 1400 grams, and have an average shred characterization of at least 10% by weight large pieces. More typically, the structured plant protein products will have protein fibers that are at least 55% aligned, have average shear strength of at least 1800 grams, and have an average shred characterization of at least 15% by weight large pieces. In exemplary embodiment, the structured plant protein products will have protein fibers that are at least 55% aligned, have average shear strength of at least 2000 grams, and have an average shred characterization of at least 17% by weight large pieces. In another exemplary embodiment, the structured plant protein products will have protein fibers that are at least 55% aligned, have average shear strength of at least 2200 grams, and have an average shred characterization of at least 20% by weight large pieces.

### (II) Animal Meat

The emulsified meat products, in addition to structured plant protein products, also comprise animal meat. The animal meat used is preferably any meat useful for forming sausages, frankfurters or other emulsified meat products formed by filling a permeable or impermeable casing with a meat material or a meat which is useful in ground meat applications such as hamburgers, meat loaf, and minced meat products.

The term “meat” is understood to apply not only to the flesh of cattle, swine, sheep and goats, but also horses, whales and other mammals, poultry and fish. The term “meat by-products” is intended to refer to those non-rendered parts of the carcass of slaughtered animals including but not restricted to mammals, poultry and the like and including such constituents as are embraced by the term “meat by-products” in the Definitions of Feed Ingredients published by the Association of American Feed Control Officials, Incorporated. The terms “meat,” and “meat by-products,” are understood to apply to all of those animal, poultry and marine products defined by association.

The animal meat compositions, in addition to structured plant protein product, also comprise animal meat. By way of example, meat and meat ingredients defined specifically for the various structured vegetable protein patents include intact or ground beef, pork, lamb, mutton, horsemeat, goat meat, meat, fat and skin of poultry (domestic fowl such as chicken, duck, goose or turkey) and more specifically flesh tissues from any fowl (any bird species), fish flesh derived from both fresh and salt water fish such as catfish, tuna, sturgeon, salmon, bass, muskie, pike, bowfin, gar, paddlefish, bream, carp, trout, walleye, snakehead and crappie, animal flesh of shellfish and crustacean origin, animal flesh trim and animal tissues derived from processing such as frozen residue from sawing frozen fish, chicken, beef, pork etc., chicken skin, pork skin, fish skin, animal fats such as beef fat, pork fat, lamb fat, chicken fat, turkey fat, rendered animal fat such as lard and tallow, flavor enhanced animal fats, fractionated or further processed animal fat tissue, finely textured beef, finely textured pork, finely textured lamb, finely textured chicken, low temperature rendered animal tissues such as low temperature rendered beef and low temperature rendered pork, mechanically separated meat or mechanically deboned meat (MDM) (meat flesh removed from bone by various mechanical means) such as mechanically separated beef, mechanically separated pork, mechanically separated fish, mechanically separated chicken, mechanically separated turkey, any cooked animal flesh and organ meats derived from any animal species. Meat flesh should be extended to include muscle protein fractions derived from salt fractionation of the animal tissues, protein ingredients derived from isoelectric fractionation and precipitation of animal muscle or meat and hot boned meat as well as mechanically prepared collagen tissues and gelatin. Additionally, meat, fat, connective tissue and organ meats of game animals such as buffalo, deer, elk, moose, reindeer, caribou, antelope, rabbit, bear, squirrel, beaver, muskrat, opossum, raccoon, armadillo and porcupine as well as well as reptilian creatures such as snakes, turtles and lizards should be considered meat.

By way of example meat includes striated muscle which is skeletal or that which is found, for example, in the tongue, diaphragm, heart, or esophagus, with or without accompanying overlying fat and portions of the skin, sinew, nerve and blood vessels which normally accompany the meat flesh. Examples of meat by-products are organs and tissues such as lungs, spleens, kidneys, brain, liver, blood, bone, partially defatted low-temperature fatty tissues, stomachs, intestines free of their contents, and the like. Poultry by-products include non rendered clean parts of carcasses of slaughtered poultry such as heads, feet, and viscera, free from fecal content and foreign matter.

It is also envisioned that a variety of meat qualities may be utilized in the invention depending upon the product's intended use. For example, whole meat muscle that is either ground or in chunk or steak form may be utilized. In an additional embodiment whole muscle meat pieces may be used that are unaltered or are intact pieces of meat. In a further embodiment, mechanically deboned meat (MDM) may be utilized. In the context of the present invention, MDM is any mechanically deboned meat including a meat paste that is recovered from a variety of animal bones, such as, beef, pork and chicken bones, using commercially available equipment. MDM is generally an untexturized comminuted product that is devoid of the natural fibrous texture found in intact muscles. In other embodiments, a combination of MDM and whole meat muscle may be utilized.

It is well known in the art to produce mechanically deboned or separated raw meats using high-pressure machinery that separates bone from animal tissue, by first crushing bone and adhering animal tissue and then forcing the animal tissue, and not the bone, through a sieve or similar screening device, or by simply pressing the soft animal flesh away from intact bone using pressure associated with a screening device. The animal tissue in the present invention comprises muscle tissue, organ tissue, connective tissue, and skin. The process forms an untexturized, paste-like blend of soft animal tissue with a batter-like consistency and is commonly referred to as MDM. This paste-like blend has a particle size of from about 0.25 to about 10 millimeters. In another embodiment, the particle size is up to about 5 millimeters. In a further embodiment, the particle size is up to about 3 millimeters.

Although the animal tissue, also known as raw meat, is preferably provided in at least substantially frozen form so as to avoid microbial spoilage prior to processing, once the meat is ground, it is not necessary to freeze it to provide cutability into individual strips or pieces. Unlike meat meal, raw meat has a natural high moisture content of above about 50% and the protein is not denatured.

The raw animal meat used in the present invention may be any edible meat suitable for human consumption. The meat may be non-rendered, non-dried, raw meat, raw meat products, raw meat by-products, and mixtures thereof. The animal meat or meat products including the comminuted meat products are generally supplied daily in a fresh refrigerated state, completely frozen or at least a substantially frozen condition so as to avoid microbial spoilage. In one embodiment, the temperature of the animal meat is below about 40° C. In another embodiment, the temperature of the meat is below about 10° C. In yet another embodiment, the temperature of the meat is from about −4° C. to about 6° C. In a further embodiment, the temperature of the meat is from about −2° C. to about 2° C. While refrigerated or chilled meat may be used, it is generally impractical to store large quantities of unfrozen meat for extended periods of time at a plant site. The frozen products provide a longer lay time than do the refrigerated or chilled products. Non-limiting examples of animal meat products which may be used in the process of the present invention include pork shoulder, beef shoulder, beef flank, turkey thigh, beef liver, ox heart, pig heart, pork heads, pork skirt, beef mechanically deboned meat, pork mechanically deboned meat and chicken mechanically deboned meat.

In lieu of frozen animal meat, the animal meat may be freshly prepared for the preparation of the restructured meat product, as long as the freshly prepared animal meat meets the temperature conditions of not more than about 40° C.

The moisture content of the raw frozen or unfrozen meat is generally at least about 50% by weight, and most often from about 60% by weight to about 75% by weight, based upon the weight of the raw meat. In embodiments of the invention, the fat content of the raw frozen or unfrozen meat may be at least about 2% by weight and generally from about 15% by weight to about 30% by weight of the raw meat. In other embodiments of the invention, meat products having a fat content of less than about 10% by weight and defatted meat products may be used.

The frozen or chilled meat may be stored at a temperature of about −18° C. to about 0° C. It is generally supplied in 20 kilogram blocks. Upon use, the blocks are permitted to thaw up to about 110° C., that is, to defrost, but in a tempered environment. Thus, the outer layer of the blocks, for example up to a depth of about ¼′, may be defrosted or thawed but still at a temperature of about 0° C., while the remaining inner portion of the blocks, while still frozen, are continuing to thaw and thus keeping the outer portion at below about 10° C.

### (III) Process for Producing Food Products Comprising Animal Meat and Simulated Animal Meat Compositions

Another aspect of the invention provides a process for producing food products comprising animal meat compositions. An animal meat composition may comprise a mixture of animal meat and structured plant protein product, or it may comprise structured plant protein product. Such a process generally comprises hydrating the structured plant protein product, reducing its particle size if necessary, optionally flavoring and coloring the structured plant protein product, optionally mixing it with animal meat, and further processing the composition into a food product.

(a) Hydrating the Structured Plant Protein Product

The structured plant protein product may be mixed with water to rehydrate it. The amount of water added to the structured plant protein product can and will vary. The ratio of water to structured plant protein product may range from about 1.5:1 to about 4:1. In one embodiment, the ratio of water to structured plant protein product may be about 2.5:1.

The particle size of the structured protein product may be further reduced by grinding, shredding, cutting, or chopping the hydrated product. The particle size can and will vary depending upon the processed meat product being made. Typically, the reduced hydrated product has an average particle size of from about 0.5 mm to about 40.0 mm. In one embodiment, the reduced hydrated product has an average particle size of from about 1.0 mm to about 30.0 mm. In another embodiment, the reduced hydrated product has an average particle size of from about 1.0 mm to about 20.0 mm. In a further embodiment, the reduced hydrated product has an average particle size of from about 1.0 mm to about 15.0 mm. In an additional embodiment, the reduced hydrated product has an average particle size of from about 1.5 mm to about 10.0 mm. In yet another embodiment, the reduced hydrated product has an average particle size of from about 2.0 mm to about 6.0 mm.

(b) Optionally Blend with Animal Meat

The hydrated, structured plant protein product may be blended with animal meat to produce animal meat compositions. Any of the animal meats detailed in II above or otherwise known in the art may be utilized. In general, the structured plant protein product will be blended with animal meat that has a similar particle size. Typically, the amount of structured plant protein product in relation to the amount of animal meat in the animal meat compositions can and will vary depending upon the composition's intended use. By way of example, when a significantly vegetarian composition that has a relatively small degree of animal flavor is desired, the concentration of animal meat in the animal meat composition may be about 45%, 40%, 35%, 30%, 25%, 20%, 15%, 10%, 5%, 2%, or 0.01% by weight. In a further embodiment the vegetarian composition may contain no animal meat. Alternatively, when an animal meat composition having a relatively high degree of animal meat flavor is desired, the concentration of animal meat in the animal meat composition may be about 50%, 55%, 60%, 65%, 70%, or 75% by weight. Consequently, the concentration of structured plant protein product in the animal meat composition may be about 25%, 30%, 35%, 40%, 45%, 50%, 55%, 60%, 65%, 70%, 75%, 80%, 85%, 90%, 95%, or 99% by weight.

Depending upon the food product, the animal meat is typically pre-cooked to partially dehydrate the flesh and prevent the release of those fluids during further processing applications (e.g., such as retort cooking), to remove natural oils that may have strong flavors, to coagulate the protein in the animal meat and loosen the meat from the skeleton, or to develop desirable and textural flavor properties. The pre-cooking process may be carried out in steam, water, oil, hot air, smoke, or a combination thereof. The animal meat is generally heated until the internal temperature is between 60° C. and 85° C.

(c) Optionally Add a Coloring Agent

It is also envisioned that the animal meat composition or simulated meat composition may be combined with a suitable coloring agent such that the color of the composition resembles the color of animal meat it simulates. The compositions of the invention may be colored to resemble dark animal meat or light animal meat. By way of example, the composition may be colored with a natural colorant, a combination of natural colorants, an artificial colorant, a combination of artificial colorants, or a combination of natural and artificial colorants. Suitable examples of natural colorants approved for use in food include annatto (reddish-orange), anthocyanins (red to blue, depends upon pH), beet juice, beta-carotene (orange), beta-APO 8 carotenal (orange), black currant, burnt sugar; canthaxanthin (pink-red), caramel, carmine/carminic acid (bright red), cochineal extract (red), curcumin (yellow-orange); lutein (red-orange); mixed carotenoids (orange), monascus (red-purple, from fermented red rice), paprika, red cabbage juice, riboflavin (yellow), saffron, titanium dioxide (white), and turmeric (yellow-orange). Suitable examples of artificial colorants approved for use in food include FD&C (Food Drug & cosmetics) Red Nos. 3 (carmosine), 4 (fast red E), 7 (ponceau 4R), 9 (amaranth), 14 (erythrosine), 17 (allura red), 40 (allura red AC) and FD&C Yellow Nos. 5 (tartrazine), 6 (sunset yellow) and 13 (quinoline yellow). Food colorants may be dyes, which are powders, granules, or liquids that are soluble in water. Alternatively, natural and artificial food colorants may be lake colors, which are combinations of dyes and insoluble materials. Lake colors are not oil soluble, but are oil dispersible; they tint by dispersion.

The type of colorant or colorants and the concentration of the colorant or colorants will be adjusted to match the color of the animal meat to be simulated. The final concentration of a natural food colorant may range from about 0.01% percent to about 4% by weight.

The color system may further comprise an acidity regulator to maintain the pH in the optimal range for the colorant. The acidity regulator may be an acidulent. Examples of acidulents that may be added to food include citric acid, acetic acid (vinegar), tartaric acid, malic acid, fumaric acid, lactic acid, phosphoric acid, sorbic acid, and benzoic acid. The final concentration of the acidulent in an animal meat composition may range from about 0.001% to about 5% by weight. The final concentration of the acidulent may range from about 0.01% to about 2% by weight. The final concentration of the acidulent may range from about 0.1% to about 1% by weight. The acidity regulator may also be a pH-raising agent, such as disodium diphosphate.

(d) Addition of Optional Ingredients

The simulated animal meat compositions or the compositions blended with animal meat may optionally include a variety of flavorings, spices, antioxidants, or other ingredients to nutritionally enhance the final food product. As will be appreciated by a skilled artisan, the selection of ingredients added to the animal meat composition can and will depend upon the food product to be manufactured.

The animal meat compositions or simulated meat compositions may further comprise an antioxidant. The antioxidant may prevent the oxidation of the polyunsaturated fatty acids (e.g., omega-3 fatty acids) in the animal meat, and the antioxidant may also prevent oxidative color changes in the colored structured plant protein product and the animal meat. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o- is anthranilic acid, p- is PABA), butylated hydroxyanisole (BHA), butylated hydroxytoluene (BHT), caffeic acid, canthaxantin, alpha-carotene, beta-carotene, beta-caraotene, beta-apo-carotenoic acid, camosol, carvacrol, catechins, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids, flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, ice bran extract, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., Ionox 100), 2,4-(tris-3′,5′-bi-tert-butyl-4′-hydroxybenzyl)-mesitylene (i.e., Ionox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. The concentration of an antioxidant in an animal meat composition may range from about 0.0001% to about 20% by weight. In another embodiment, the concentration of an antioxidant in an animal meat composition may range from about 0.001% to about 5% by weight. In yet another embodiment, the concentration of an antioxidant in an animal meat composition may range from about 0.01% to about 1% by weight.

In an additional embodiment, the animal meat compositions or simulated meat compositions or simulated meat compositions may further comprise a flavoring agent such as an animal meat flavor, an animal meat oil, spice extracts, spice oils, natural smoke solutions, natural smoke extracts, yeast extract, and shiitake extract. Additional flavoring agents may include onion flavor, garlic flavor, or herb flavors. The animal meat composition may further comprise a flavor enhancer. Examples of flavor enhancers that may be used include salt (sodium chloride), glutamic acid salts (e.g., monosodium glutamate), glycine salts, guanylic acid salts, inosinic acid salts, 5′-ribonucleotide salts, hydrolyzed proteins, and hydrolyzed vegetable proteins.

In an additional embodiment, the animal meat compositions or simulated animal meat compositions may further comprise a thickening or a gelling agent, such as alginic acid and its salts, agar, carrageenan and its salts, processed Eucheuma seaweed, gums (carob bean, guar, tragacanth, and xanthan), pectins, sodium carboxymethylcellulose, and modified starches.

In a further embodiment, the animal meat compositions or simulated animal meat compositions may further comprise a nutrient such as a vitamin, a mineral, an antioxidant, an omega-3 fatty acid, or an herb. Suitable vitamins include Vitamins A, C, and E, which are also antioxidants, and Vitamins B and D. Examples of minerals that may be added include the salts of aluminum, ammonium, calcium, magnesium, and potassium. Suitable omega-3 fatty acids include docosahexaenoic acid (DHA). Herbs that may be added include basil, celery leaves, chervil, chives, cilantro, parsley, oregano, tarragon, and thyme.

(e) Variety of Food Products

The animal meat compositions created from the combination of the structured plant protein product, animal meat, and other ingredients may be processed into a variety of food product for either human or animal consumption. By way of non-limiting example, the final product may be an animal meat composition for human consumption that simulates a ground meat product, a steak product, a sirloin tip product, a kebab product, a shredded product, a chunk meat product, a nugget product, an emulsified meat product, a filled casing product, such as sausages or frankfurters, or a ground meat product, such as hamburgers, meat loaf or minced meat products. Any of the foregoing products may be placed in a tray with overwrap, vacuum packed, retort canned or pouched, or frozen.

It is also envisioned that the animal compositions of the present invention may be utilized in a variety of animal diets. In one embodiment, the final product may be an animal meat composition formulated for companion animal consumption. In another embodiment, the final product may be an animal meat composition formulated for agricultural or zoo animal consumption. A skilled artisan can readily formulate the meat compositions for use in companion animal, agricultural animal or zoo animal diets.

(f) Emulsified Meat Products

The emulsified meat product is formed by combining the structured plant protein product and animal meat compositions. In another embodiment, water is added to the structured plant protein for hydration and then the hydrated structured plant protein is added to the animal meat to form the meat emulsion. The meat emulsion is then formed into the final meat product.

The product and process of producing the emulsion meat product is completed by combining the structured plant protein product and animal meat per the disclosed percentages in III(b) based on the intend final meat product. In an additional embodiment, an amount of water is added to hydrate the structured meat product as discussed in III(a). Selected amounts of animal meat, water, and the structured plant protein product, within the ranges set forth above, are added together in a mixing or chopping bowl, together with any additional desired ingredients such as flavorings, colorants, and preservatives.

The structured plant protein product is intact when it is combined with the other ingredients. By intact, it is meant that the structured plant protein product has not been chopped, ground, shredded, or broken apart before it is combined with the animal meat. The structured plant protein exhibits intact particulates that when combined with the animal meat produce an emulsified meat product with improved texture. The mixture is then blended by stirring, agitating, or mixing the ingredients for a period of time sufficient to form a homogenous meat emulsion and to extract meat protein from the cells in which it is contained. Alternatively, the ingredients can be added separately after each previous ingredient is thoroughly mixed into the mixture, e.g., the water and meat material can be thoroughly blended, the structured plant protein product added and blended into the mixture, and other ingredients added and blended into the mixture after the meat material, water, and protein plant product are homogeneously mixed together.

In another embodiment, after the structured plant protein product is hydrated it is processed before it is combined with the animal meat and other ingredients. Non-limiting examples of processes used include chopping, shredding, cutting, grinding, or any method that breaks the structured plant protein product into pieces. The processed structured plant protein product will exhibit intact particulates that when combined with the animal meat produce an emulsified meat product with improved texture. The processed structured plant protein product is then blended as discussed above.

In another embodiment, the structured plant protein product is combined with the comminuted animal meat. The comminuted animal meat is prepared according to traditional methods for forming a comminuted meat paste. The structured plant protein product is then combined with the meat paste and processed to form the emulsified meat product. The structured plant protein product that includes intact particulates is combined with the comminuted animal meat to form the meat emulsion product.

In another embodiment, the combination of ingredients including the structured plant protein product and comminuted meat or MDM can be further processed for storage. The processing could include cooking, partial cooking, freezing, or any method known in the art for producing a shelf stable product. After the mixture of the structured plant protein product and comminuted meat have been produced for shelf stability, the mixture can be stored on site or transported off site for subsequent use in preparation of meat emulsions.

Conventional means for stirring, agitating, or mixing the mixture may be used to effect the blending and create the meat emulsion. The blending of the meat emulsion includes a bowl chopper which chops the materials in the mixture with a knife, and a mixer/emulsifier system which ultimately minces a pre-extracted mixture of meat and highly structured plant protein ingredient. Non-limiting exemplary copper/mixer/emulsifiers include a bowl chopper such as the Alpina model PBV 90 20, a mince mill such as a Stefhan model Microcut MC 15, an emulsifier such as the Cozzini continuous emulsifier model AR 701, or the Hobart Food Cutter Model No. 84142.

After the mixture of the ingredients has been blended to form the meat emulsion, the meat emulsion may be used to prepare meat products. Non-limiting examples of products that can be formed by the meat emulsion include sausage, frankfurters, and similar products. The meat emulsion can be stuffed into permeable or impermeable casings or membranes to form frankfurters and frankfurter-like products.

After the meat emulsion is formed into the desired final meat product it is cooked. Any method known in the art for cooking the final meat product can be used. Non-limiting examples of cooking methods include controlled humidity, hot water cooking, steam cooking, and oven methods, including microwave, traditional, and convection.

In another embodiment, the final meat product can be partially cooked for finishing at a later time or frozen either in an uncooked state, partially cooked state, or cooked state.

In one embodiment, the filled sausage casings are cooked to form the meat products. The stuffed casings may be cooked by any conventional means for cooking meats, and preferably are cooked to an internal temperature of from about 70° C. to about 90° C. In another embodiment, the filled sausage casings are cooked by heating the casings in hot water, preferably at about 80° C., to an internal temperature of about 70° C. to about 80° C. In a further embodiment, the filled sausage casings are cooked in a water kettle cooker.

The emulsion meat product either cooked or uncooked may also be packed and sealed in cans in a conventional manner and employing conventional sealing procedures in preparation for sterilization by retorting.

The resulting meat emulsion product containing the structured plant protein product has improved firmness, texture, springiness, and chewiness relative to meat emulsions formed with comminuted meat and/or unrefined soy protein materials. The meat emulsion product containing the structured plant protein product displays substantial compression stability in meat emulsions containing low and medium grade meats (meats with little structural functionality), indicating the structured plant protein product contributes added texture to the meat emulsion.

### DEFINITIONS

The term “extrudate” as used herein refers to the product of extrusion. In this context, the structured plant protein products comprising protein fibers that are substantially aligned may be extrudates in some embodiments.

The term “fiber” as used herein refers to a structured plant protein product having a size of approximately 4 centimeters in length and 0.2 centimeters in width after the shred characterization test detailed in Example 4 is performed.

The term “animal meat” as used herein refers to the flesh, whole meat muscle, or parts thereof derived from an animal.

The term “gluten” as used herein refers to a protein fraction in cereal grain flour, such as wheat, that possesses a high content of protein as well as unique structural and adhesive properties.

The term “gluten free starch” as used herein refers to modified tapioca starch. Gluten free or substantially gluten free starches are made from wheat, corn, and tapioca based starches. They are gluten free because they do not contain the gluten from wheat, oats, rye or barley.

The term “large piece” as used herein is the manner in which a structured plant protein product's shred percentage is characterized. The determination of shred characterization is detailed in Example 4.

The term “protein fiber” as used herein refers the individual continuous filaments or discrete elongated pieces of varying lengths that together define the structure of the plant protein products of the invention. Additionally, because the plant protein products of the invention have protein fibers that are substantially aligned, the arrangement of the protein fibers impart the texture of whole meat muscle to the plant protein products.

The term “simulated” as used herein refers to a meat composition that contains no animal meat.

The term “soy cotyledon fiber” as used herein refers to the polysaccharide portion of soy cotyledons containing at least about 70% dietary fiber. Soy cotyledon fiber typically contains some minor amounts of soy protein, but may also be 100% fiber. Soy cotyledon fiber, as used herein, does not refer to, or include, soy hull fiber. Generally, soy cotyledon fiber is formed from soybeans by removing the hull and germ of the soybean, flaking or grinding the cotyledon and removing oil from the flaked or ground cotyledon, and separating the soy cotyledon fiber from the soy material and carbohydrates of the cotyledon.

The term “soy protein concentrate” as used herein is a soy material having a protein content of from about 65% to less than about 90% soy protein on a moisture-free basis. Soy protein concentrate also contains soy cotyledon fiber, typically from about 3.5% up to about 20% soy cotyledon fiber by weight on a moisture-free basis. A soy protein concentrate is formed from soybeans by removing the hull and germ of the soybean, flaking or grinding the cotyledon and removing oil from the flaked or ground cotyledon, and separating the soy protein and soy cotyledon fiber from the soluble carbohydrates of the cotyledon.

The term “soy flour” as used herein, refers to a comminuted form of defatted soybean material, preferably containing less than about 1% oil, formed of particles having a size such that the particles can pass through a No. 100 mesh (U.S. Standard) screen. The soy cake, chips, flakes, meal, or mixture of the materials are comminuted into soy flour using conventional soy grinding processes. Soy flour has a soy protein content of about 49% to about 65% on a moisture free basis. Preferably the flour is very finely ground, most preferably so that less than about 1% of the flour is retained on a 300 mesh (U.S. Standard) screen.

The term “soy protein isolate” as used herein is a soy material having a protein content of at least about 90% soy protein on a moisture free basis. A soy protein isolate is formed from soybeans by removing the hull and germ of the soybean from the cotyledon, flaking or grinding the cotyledon and removing oil from the flaked or ground cotyledon, separating the soy protein and carbohydrates of the cotyledon from the cotyledon fiber, and subsequently separating the soy protein from the carbohydrates.

The term “strand” as used herein refers to a structured plant protein product having a size of approximately 2.5 to about 4 centimeters in length and greater than approximately 0.2 centimeter in width after the shred characterization test detailed in Example 4 is performed.

The term “starch” as used herein refers to starches derived from any native source. Typically sources for starch are cereals, tubers, roots, legumes, and fruits.

The term “wheat flour” as used herein refers to flour obtained from the milling of wheat. Generally speaking, the particle size of wheat flour is from about 14 to about 120 μm.

The term “comminuted meat” as used herein refers to a meat paste that is recovered from an animal carcass. The meat, on the bone is forced through a deboning device such that meat is separated from the bone and reduced in size. Meat that is off the bone would not be further treated with a deboning device. The meat is separated from the meat/bone mixture by forcing through a cylinder with small diameter holes. The meat acts as a liquid and is forced through the holes while the remaining bone material remains behind. The fat content of the comminuted meat may be adjusted upward by the addition of animal fat.

The term “meat emulsion” or “emulsified meat” as used herein refers to a flowable meat product, such as a meat slurry, where the meat is more malleable than unprocessed meats.

The invention having been generally described above, may be better understood by reference to the examples described below. The following examples represent specific but non-limiting embodiments of the present invention.

### EXAMPLES

Examples 1 and 2 illustrate various embodiments of the invention.

### Example 1

### Lean Meat Replacement Comprising a Structured Plant Protein Ingredient and Mechanically Separated Meat

An emulsified meat product was developed in which part of the lean meat was replaced with a less expensive ingredient mixture comprising hydrated, shredded structured plant protein ingredient and comminuted meat, such as mechanically separated meat. One of the objectives for developing this emulsified meat product was to reduce the cost of the product, without sacrificing taste or texture.

The structured plant protein ingredient comprised isolated soy protein (ISP), wheat gluten, wheat starch, soy fiber, L-cysteine, and dicalcium phosphate. The protein fibers in the structured plant protein ingredient were substantially aligned. The structured plant protein ingredient was hydrated and shredded such that it possessed specific textural characteristics as defined by SP1455. The comminuted meat was mechanically deboned meat (MDM) comprised chicken, fish, beef, pork, lamb, and poultry meats. The lean meat replacement mixture was made by combining the shredded structured plant protein ingredient, the mechanically deboned meat, water, salt, flavoring, antioxidants, sodium acid pyrophosphate (SAPP), and sodium tripolyphosphate (STP).

The lean meat replacement mixture was used to replace a portion of the more expensive lean meat ingredients, which are defined as raw fresh or raw frozen meat materials having less than 30% fat. As shown in Table 1, the control emulsified meat product comprised 28% lean meat, whereas the test emulsified meat product comprised 13% lean meat and 15% lean meat replacement mixture.

TABLE 1
Emulsified Meat Product Compositions.

| | Control | Test Product |
|---|---|---|
| Ingredient | Product (%) | (%) |
| Beef (85% chemical lean) | 28.00 | 13.00 |
| Beef Hearts | 10.00 | 10.00 |
| Pork Fat Trim (50% chemical lean) | 20.00 | 20.00 |
| Beef Fat | 4.00 | 4.00 |
| Water | 26.00 | 26.00 |
| Salt | 1.80 | 1.80 |
| Cure Salt (6.25% sodium nitrite) | 0.20 | 0.20 |
| Phosphate | 0.30 | 0.30 |
| Lean Meat Replacement Mixture | 0.00 | 15.00 |
| (Structured Plant Protein Ingredient, | | |
| MDM Chicken, Salt, etc.) | | |
| Sodium Caseinate | 0.80 | 0.80 |
| Isolated Soy Protein (ISP) | 3.00 | 3.00 |
| Modified Wheat Starch | 5.30 | 5.30 |
| Seasoning | 0.60 | 0.60 |
| Total | 100.00 | 100.00 |

The emulsified meat products were prepared by grinding the lean meats though a though a 3-mm grinder plate and grinding the fat meats through a 6-mm grinder plate. The ground lean meats were chopped at high speed with the salt, curing salt, phosphate and ⅓ of the formulation water for 3-4 minutes. The isolated soy protein was added, along with the second ⅓ of the water and the mixture was chopped at high speed for 1 minute. The ground fat meats were added and the mixture was chopped at high speed for 2 minutes. The rest of the ingredients (e.g., lean meat replacement mixture) were added and the mixture was chopped at high speed to a final meat batter (emulsion) of 55-60° F. (12.5-15.5° C.). Cellulose casing was filled with the batter, and then the emulsified meat products were smoked, cooked, chilled, and packaged.

The taste of the emulsified meat product containing 15% structured plant protein ingredient was indistinguishable from the control emulsified meat product.

### Example 2

### Textural Comparison of Emulsified Meat Products Prepared via Different Methods

Example 1 revealed that the structured plant protein ingredient could be added directly to the raw meat batter prior to emulsification. This experiment was designed to test whether particle size reduction using a bowl chopper, such as an Alpina model PBV 90 20, or a mince mill, such as a Stefhan model Microcut MC 15, would produce a better-textured emulsified meat product.

Table 2 lists the compositions of three different emulsified meat preparations. The control emulsified meat product comprised 60% MDM (mechanically deboned chicken) and no structured plant protein (SPP) ingredient or soy protein. One test product comprised 45% MDM chicken, no SPP ingredient, and 3% soy protein. The second test product comprised 45% MDM chicken, 2% SPP ingredient, and 3% soy protein.

TABLE 2
Emulsified Meat Product Compositions

| | | Test without | |
|---|---|---|---|
| Ingredient | Control | SPP | Test with SPP |
| MDM Chicken | 60 | 45 | 45 |
| Pork Fat | 15 | 15 | 15 |
| Pork Skin Emulsion (50% | 10 | 10 | 10 |
| pork skin and 50% water) | | | |
| Corn Starch | 2 | 2 | 2 |
| Salt | 2 | 2 | 2 |
| Cure Salt | 0.2 | 0.2 | 0.2 |
| Spice Mixture | 2 | 2 | 2 |
| Structured Plant Protein | 0 | 0 | 2 |
| Ingredient | | | |
| SUPRO 500E | 0 | 3 | 3 |
| Water | 8.8 | 20.8 | 18.8 |
| Total | 100 | 100 | 100 |

The compositions were mixed together essentially as described in Example 1, except a first set of emulsified meat products was chopped using a bowl chopper and a second set was prepared using a mince mill for comminution to form a mixture of fine ingredient particles. For the second set, the meats were first blended with salt and phosphate using a ribbon or paddle blender to extract the salt soluble proteins, and remaining ingredients were blended into the extracted meat mixture prior to mincing.

A texture analysis of the different emulsified meat preparation was conducted using a TA.XT2i Texture Analyzer (Stable MicroSystems, Ltd., Surrey, UK). Table 3 presents the results (hardness is expressed in grams; chewiness is unit less). The emulsified meat product comprising the SPP ingredient that was prepared in the bowl chopper prior to emulsification had increased hardness and chewiness relative to the control emulsified meat product or the test product without SPP ingredient.

TABLE 3
Textural Characteristics

| | Bowl Chopper | | | Mince Mill | | |
|---|---|---|---|---|---|---|
| | | Test | | | | Test |
| | | w/o | Test with | | Test w/o | with |
| | Control | SPP | SPP | Control | SPP | SPP |
| Hardness | 2358 | 2193 | 3150 | 2939 | 2111 | 2476 |
| Chewiness | 444 | 318 | 617 | 534 | 394 | 484 |

### Example 3

### Determination of Shear Strength

Shear strength of a sample is measured in grams and may be determined by the following procedure. Weigh a sample of the structured plant protein product and place it in a heat sealable pouch and hydrate the sample with approximately three times the sample weight of room temperature tap water. Evacuate the pouch to a pressure of about 0.01 Bar and seal the pouch. Permit the sample to hydrate for about 12 to about 24 hours. Remove the hydrated sample and place it on the texture analyzer base plate oriented so that a knife from the texture analyzer will cut through the diameter of the sample. Further, the sample should be oriented under the texture analyzer knife such that the knife cuts perpendicular to the long axis of the textured piece. A suitable knife used to cut the extrudate is a model TA-45, incisor blade manufactured by Texture Technologies (USA). A suitable texture analyzer to perform this test is a model TA, TXT2 manufactured by Stable Micro Systems Ltd. (England) equipped with a 25, 50, or 100 kilogram load. Within the context of this test, shear strength is the maximum force in grams needed to puncture through the sample.

### Example 4

### Determination of Shred Characterization

A procedure for determining shred characterization may be performed as follows. Weigh about 150 grams of a structured plant protein product using whole pieces only. Place the sample into a heat-sealable plastic bag and add about 450 grams of water at 25° C. Evacuate the bag to a pressure of about 0.01 bar and allow the contents to hydrate for about 60 minutes. Place the hydrated sample in the bowl of a Kitchen Aid mixer model KM14G0, or like model, equipped with a single blade paddle and mix the contents at 130 rpm for two minutes. Scrape the paddle and the sides of the bowl, returning the scrapings to the bottom of the bowl. Repeat the mixing and scraping two times. Remove a sample of about 200 g from the bowl. Separate this sample into three groups. Group 1 is the portion of the sample having fibers at least 4 centimeters in length and at least 0.2 centimeters wide. Group 2 is the portion of the sample having strands between 2.5 cm and 4.0 cm long, and which are ≧0.2 cm wide. Group 3 is the remaining portion of the sample after separation into Groups 1 and 2. Weigh the samples of Groups 1 and 2 and record the weights. Add together the weights of Group 1 and 2 and divide by the starting weight (e.g. ˜200 g). This determines the percentage of large pieces in the sample. If the resulting value is below 15%, or above 20%, the test is complete. If the value is between 15% and 20%, then weigh out another 200 g from the bowl, separate the mixture into Groups 1, 2, and 3 and perform the calculations again.

### Example 5

### Production of Structured Plant Protein Products

The following extrusion process may be used to prepare the colored structured plant protein products of the invention. Added to a dry blend mixing tank are the following: One thousand kilograms (kg) Supro 620 (soy isolate), 440 kg wheat gluten, 171 kg wheat starch, 34 kg soy cotyledon fiber, 10 kg of xylose, 9 kg dicalcium phosphate, and 1 kg L-cysteine. The contents are mixed to form a dry blended soy protein mixture. The dry blend is then transferred to a hopper from which the dry blend is introduced into a preconditioner along with 480 kg of water to form a conditioned soy protein pre-mixture. The conditioned soy protein pre-mixture is then fed to a twin-screw extrusion apparatus (Wenger Model TX-168 extruder by Wenger Manufacturing, Inc. (Sabetha, Kans.)) at a rate of not more than 25 kg/minute. The extrusion apparatus comprises five temperature control zones, with the protein mixture being controlled to a temperature of from about 25° C. in the first zone, about 50° C. in the second zone, about 95° C. in the third zone, about 130° C. in the fourth zone, and about 150° C. in the fifth zone. The extrusion mass is subjected to a pressure of at least about 400 psig in the first zone up to about 1500 psig in the fifth zone. Water, 60 kg, is injected into the extruder barrel, via one or more injection jets in communication with a heating zone. The molten extruder mass exits the extruder barrel through a die assembly consisting of a die and a back plate. As the mass flows through the die assembly the protein fibers contained within are substantially aligned with one another forming a fibrous extrudate. As the fibrous extrudate exits the die assembly, it is cut with flexible knives and the cut mass is then dried to a moisture content of about 10% by weight.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

What is claimed is:

1. A process for producing an emulsified meat product, the process comprising:
(a) extruding a plant protein material under conditions of elevated temperature and pressure to form a structured plant protein product comprising protein fibers that are substantially aligned, wherein the plant protein material is selected from the group consisting of legumes, corn, peas, canola, sunflowers, sorghum, rice, amaranth, potato, tapioca, arrowroot, canna, lupin, rape, wheat, oats, rye, barley, and mixtures thereof and wherein the structured plant protein product has an average shear strength of at least 2000 grams and an average shred characterization of at least 17%; and
(b) combining the structured plant protein product with an animal meat to form an emulsified meat product.

2. The process of claim 1, wherein the structured plant protein product comprises protein fibers substantially aligned in the manner depicted in the micrographic image of FIG. 1.

3. The process of claim 1, further comprising combining at least one animal meat with the plant protein material before extruding, to produce the structured plant protein product comprising protein fibers that are substantially aligned.

4. The process of claim 1, wherein the plant protein material comprises:
(a) from about 45% to about 65% soy protein on a dry matter basis;
(b) from about 20% to about 30% wheat gluten on a dry matter basis;
(c) from about 10% to about 15% wheat starch on a dry matter basis; and
(d) from about 1% to about 5% starch on a dry matter basis.

5. The process of claim 4, wherein the plant protein material further comprises dicalcium phosphate and L-cysteine.

6. The process of claim 1, wherein the extrusion temperature is from about 90° C. to about 150° C. and the pressure is from about 500 psig to about 1500 psig.

7. The process of claim 1, wherein the animal meat is selected from the group consisting of whole muscle pieces, comminuted meat, and mechanically deboned meat, and combinations thereof.

8. The process of claim 1, wherein the animal meat is derived from an animal selected from the group consisting of pork, beef, lamb, poultry, wild game, and fish.

9. The process of claim 1, wherein the emulsified meat product further includes an amount of water.

10. An animal emulsified meat composition, the animal emulsified meat composition comprising:
(a) animal meat and
(b) a structured plant protein product comprising protein fibers that are substantially aligned, the structured plant protein product comprising an extrudate of plant protein material, wherein the structured plant protein product has an average shear strength of at least 2000 grams and an average shred characterization of at least 17% and wherein the plant protein material is selected from the group consisting of legumes, corn, peas, canola, sunflowers, sorghum, rice, amaranth, potato, tapioca, arrowroot, canna, lupin, rape, wheat, oats, rye, barley, and mixtures thereof.

11. The animal emulsified meat composition of claim 10, wherein the animal emulsified meat composition further includes an amount of water.

12. The animal emulsified meat composition of claim 10, wherein the concentration of structured plant protein product present in the animal emulsified meat composition ranges from about 25% to about 99% by weight and the concentration of animal meat present ranges from about 1% to about 75% by weight.

13. The animal emulsified meat composition of claim 10, wherein the structured plant protein product comprises protein fibers substantially aligned in the manner depicted in the micrographic image of FIG. 1.

14. The animal emulsified meat composition of claim 10, wherein the animal meat is selected from the group consisting of whole muscle pieces, comminuted meat, and mechanically deboned meat.

15. The animal emulsified meat composition of claim 10, wherein the animal meat is from an animal selected from the group consisting of pork, beef, lamb, poultry, wild game, and fish.

16. The animal emulsified meat composition of claim 10, wherein the structured plant protein product comprises:
(a) from about 45% to about 65% soy protein on a dry matter basis;
(b) from about 20% to about 30% wheat gluten on a dry matter basis;
(c) from about 10% to about 15% wheat starch on a dry matter basis; and
(d) from about 1% to about 5% starch on a dry matter basis.

17. The animal emulsified meat composition of claim 16, wherein the structured plant protein product further comprises dicalcium phosphate and L-cysteine.

18. A simulated emulsified meat composition, the simulated emulsified meat composition comprising:
(a) a structured plant protein product comprising protein fibers that are substantially aligned, the structured plant protein product comprising an extrudate of plant protein material, wherein the structured plant protein product has an average shear strength of at least 2000 grams and an average shred characterization of at least 17% and wherein the plant protein material is selected from the group consisting of legumes, corn, peas, canola, sunflowers, sorghum, rice, amaranth, potato, tapioca, arrowroot, canna, lupin, rape, wheat, oats, rye, barley, and mixtures thereof.

19. The simulated emulsified meat composition of claim 18, wherein the structured plant protein product comprises protein fibers substantially aligned in the manner depicted in the micrographic image of FIG. 1.

20. The simulated emulsified meat composition of claim 18, wherein the structured plant protein product comprises:
(a) from about 45% to about 65% soy protein on a dry matter basis;
(b) from about 20% to about 30% wheat gluten on a dry matter basis;
(c) from about 10% to about 15% wheat starch on a dry matter basis; and
(d) from about 1% to about 5% starch on a dry matter basis.

21. The simulated emulsified meat composition of claim 20, wherein the structured plant protein product further comprises dicalcium phosphate and L-cysteine.

22. The simulated emulsified meat composition of claim 18, wherein an amount of water is added to the structured plant protein to create a hydrated structured plant protein product.
